(19) United States
(12) Patent Application Publication
(10) Pub. No.: US 2024/0351453 A1
(43) Pub. Date: Oct. 24, 2024

(54) Self-Charging Battery System for Electric Vehicles

(71) Applicant: Self-Charge EV Systems, LLC, St. Petersburg, FL (US)

(72) Inventors: Bruce Douglas Wertz, Saint Petersburg, FL (US); Monty Charles Trimble, Pampa, TX (US)

(73) Assignee: Self-Charge EV Systems, LLC, St. Petersburg, FL (US)

(21) Appl. No.: 18/623,100

(22) Filed: Apr. 1, 2024

Related U.S. Application Data
(60) Provisional application No. 63/460,350, filed on Apr. 19, 2023.

(51) Int. Cl. B60L 50/62; B60K 6/26; B60K 6/28; B60K 6/46; B60K 15/03; B60L 53/51

(52) U.S. Cl. CPC B60L 50/62; B60K 6/26; B60K 6/28; B60K 6/46; B60K 15/03; B60L 53/51; B60K 2015/03315; B60Y 2200/92; B60Y 2300/91; B60Y 2400/102; B60Y 2400/106; B60Y 2400/112; B60Y 2400/216

(57) ABSTRACT

A system for powering an electric vehicle includes two independent rechargeable batteries. Each battery of the two independent rechargeable batteries includes one or more battery cells. There is circuitry for charging each of the two independent rechargeable batteries and circuitry for drawing electrical energy from one or both of the two independent rechargeable batteries such that during normal operation of the electric vehicle, a first battery of the two independent rechargeable batteries is charged from any available charge potential (e.g., power from generators or solar power) and a second battery of the two independent rechargeable batteries is utilized to power the electric vehicle.

### RELATED PATENT APPLICATIONS

This application is a non-provisional patent application taking priority from U.S. Provisional Patent Application No. 63/460,350 filed Apr. 19, 2023, which is incorporated by reference.

### BACKGROUND OF THE INVENTION

The introduction of a self-charging battery system for Electric Vehicles (EVs) represents a transformative leap forward in sustainable transportation technology, offering multifaceted benefits to society and the environment.

The amount of electric energy consumed by vehicles of the future greatly impacts the electrical infrastructures and distribution systems (e.g., charging stations) required. Self-charging battery technology for EVs will create a sustainable future while elevating the quality of life for users. Once integrated into EV technology, the full potential of self-charging electric vehicles will drive positive change and prosperity for society at large.

For the environment, self-charging battery technology drastically reduces reliance on non-renewable resources, mitigates greenhouse gas emissions, and reduces air pollution in urban areas, thus safeguarding public health and environmental integrity for current and future generations. Self-charging battery technology also leads to cleaner air, quieter and cleaner streets, and a more resilient transportation infrastructure.

Battery management for electric vehicles is very difficult. The battery management system is concurrently involved in providing power to generate motion and run other components of the vehicle in a discharge mode of the battery while periodically receiving power while connected to a power source or returned power during deceleration or braking. As there are often periods of random charge and discharge cycles, the vehicle battery is constantly switching between being charged and being discharged, causing many micro-charge cycles between discharge cycles. Therefore, unless connected to an external source of power (e.g., a charging station) for a sufficiently long period of time, the vehicle battery does not achieve full charge. Note that the time to charge a depleted battery to a fully charged battery using a 7-11.5 kW charge station, a typical electric car or electric pickup truck generally takes up to 10 hours to recharge. The length of time it takes to charge an electric vehicle depends on the capacity of the batteries, available power, and the speed of the charging system.

As for discharge, vehicle range varies as a 40 kWh battery in a Nissan® Leaf® may go 149 miles between charges while a 100 kWh battery in a Tesla Model S and X may go 300 miles between charges. Some vehicles have a fast-charge mode that can reach 80% charge in 30 minutes while some take as long as 10 to 12 hours to reach an 80% charge.

Long distance driving over 250 miles with an electric vehicle is a time-consuming process and requires planning based on the location of available charging stations between the two points of travel; and enduring long waits for a sufficient charge. A nationwide Tesla® supercharger connector system allows Tesla® owners to quick charge providing enough charge for an additional travel of up to 200 miles in 15 minutes. This is still long as compared to maybe three minutes for filling a gas tank. Therefore, if one takes a 1,000 mile road trip, stopping for four or five quick charges adds an additional hour or more just for charging their vehicle, not considering any time spent waiting in line when the charging station is occupied.

Currently, less than 1% of the 250 million cars, SUVs and light-duty trucks on the road in the U.S. are electric. It is expected that this number will change dramatically over the next 17 years. On Jun. 25, 2022, CNBC aired a program in which Exxon Mobil® CEO Darren Woods stated every new passenger car sold in the world will be electric by 2040. To support that statement in part, General Motors® recently announced it plans to produce only battery-powered vehicles starting in 2035.

Recent congressional hearings indicate the US electric grid, as currently configured, would be overwhelmed without massive federally funded programs put in place to provide reliable and accessible EV charging stations across the US as well as increasing grid capacity to meet the demands of these charging stations. A New York Times® online article (Jan. 29, 2021) indicated that if every vehicle in American today was electric, the US would use 25% more electricity.

An issue with electric vehicles is weight. As the total weight of the battery is typically 25% to 35% of the overall vehicle weigh, which is typically much greater than the weight of a gasoline engine and full tank of gas, this additional weight contributes to several issues including excess tire wear (also compounded by higher torque from electric vehicles), increased bearing friction, greater inertia that must be overcome by the motors, etc. Unfortunately, there are environmental impacts to this weight, including the use of fossil fuel in manufacturing lubricants and tires, deposits of tire residue on roadways, energy usage in manufacture of the vehicle and tires, costs and impacts of infrastructure (charging stations), etc. The weight of the battery impacts all of these.

Therefore, a need exists for electric vehicles (e.g., cars, utility vehicles, vans, trucks, boats) to have the ability to recharge their internal battery without the need to plug them in to an external source.

### SUMMARY OF THE INVENTION

In one embodiment, a system for powering an electric vehicle is disclosed including two independent rechargeable batteries. Each battery of the two independent rechargeable batteries includes one or more battery cells. A battery management system is interfaced to a charge controller and a battery selector. The charge controller is electrically interfaced to each of the two independent rechargeable batteries for selectively charging one or both of the two independent rechargeable batteries when charge power is available, and the battery selector electrically interfaced to each of the two independent rechargeable batteries for routing electric energy from one or both of the two independent rechargeable batteries to power the electric vehicle. The battery management system controls the charge controller and the battery selector to charge a first battery of the two independent rechargeable batteries and route the electric energy from a second battery of the two independent rechargeable batteries during normal operation.

In another embodiment, a method for powering an electric vehicle is disclosed including providing two independent rechargeable batteries. Each battery of the two independent rechargeable batteries includes one or more battery cells. The method further includes controlling a charging of each of the two independent rechargeable batteries such that charging is provided to a first battery of the two independent rechargeable batteries while sourcing electrical power from a second battery of the two independent rechargeable batteries for use by the electric vehicle. When the second battery of the two independent rechargeable batteries reaches a low-battery threshold, controlling charging of each of the two independent rechargeable batteries such that charging is provided to the second battery of the two independent rechargeable batteries while sourcing an electrical power from the first battery of the two independent rechargeable batteries for use by the electric vehicle.

In another embodiment, a system for powering an electric vehicle is disclosed. The system includes two independent rechargeable batteries. Each battery of the two independent rechargeable batteries includes one or more battery cells. There is circuitry for charging each of the two independent rechargeable batteries and circuitry for drawing electrical energy from one or both of the two independent rechargeable batteries such that during normal operation of the electric vehicle, a first battery of the two independent rechargeable batteries is charged from any available charge potential and a second battery of the two independent rechargeable batteries is utilized to power the electric vehicle.

### BRIEF DESCRIPTION OF DRAWINGS

The invention can be best understood by those having ordinary skill in the art by reference to the following detailed description when considered in conjunction with the accompanying drawings in which:

FIG. 1 illustrates a schematic view of an electric vehicle power and drive system of the prior art.

FIG. 2 illustrates a schematic view of an improved electric vehicle power and drive system.

FIG. 3 illustrates a block diagram of an exemplary on-board computer.

FIGS. 4 and 5 illustrate exemplary program flow charts for selecting which battery is used for which purpose.

FIG. 6 illustrates a schematic view of an improved electric vehicle with the new power and drive system.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

Throughout this description, the term vehicle represents any type of vehicle including, but not limited to, cars, bicycles, motorcycles, trucks, sport utility vehicles, boats, aircraft, etc. Any vehicle for moving objects, animals, and/or people is fully anticipated and included herein. Throughout this description, the term electric vehicle represents any type of vehicle including, but not limited to, cars, bicycles, trucks, sport utility vehicles, boats, aircraft, etc., that derive power for motion from electricity, typically from battery power. Any electric vehicle for moving objects, animals, and/or people is fully anticipated and included herein.

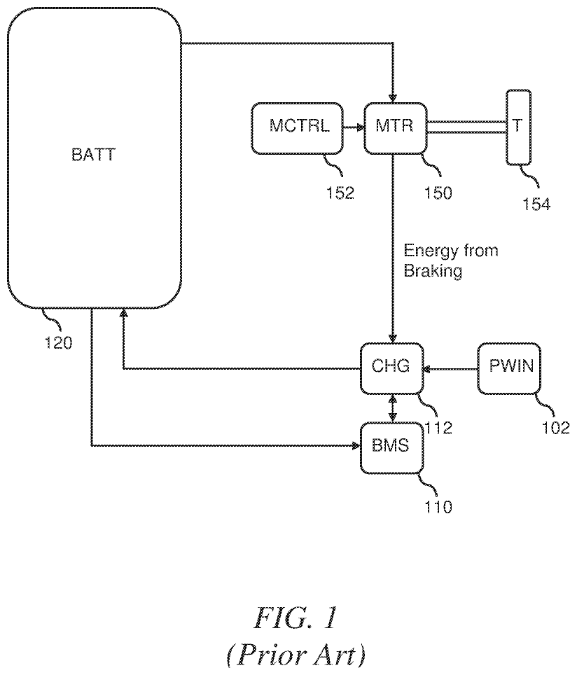

Referring to FIG. 1, a schematic view of an electric vehicle power and drive system of the prior art is shown. At the center of any prior art electric vehicle is a battery 120. The battery 120 is typically made of many battery cells arranged in any format such as in series, parallel, or both. The battery 120 is typically housed beneath the floor boards to provide a good center-of-gravity, as the battery 120 is often very heavy and the battery is connected to drive circuits such as the drive motor(s) 150 by way of very low gauge wires as the maximum amperage drawn is often very high.

The drive system of the prior art has a motor controller 152 that selectively routes power from the battery 120 to the motor 150 to rotate the tires 154 to move the vehicle in the desired direction. To improve drive distance per charge, the motor controller 152 also captures power from the motor 150 during deceleration and braking, using this power to provide some charge to the battery 120 through the battery charge circuit. 112.

When the electric vehicle is provided with an external power input 102 (e.g., connected to a charge station), the charge circuit 112 charges the battery 120, all controlled by a battery management system 110 that monitors the available charge from the battery 120 and calculates future available drive distance based upon usage data (e.g., average discharge from the battery 120) and total charge available. Note that during a typical usage scenario of a 10-minute drive to work, most electric vehicles will experience many acceleration intervals, cruising intervals, deceleration intervals, and stops, each causing periodic discharges of varying current draws (e.g., acceleration vs. cruising) and charge cycles (e.g., deceleration and braking). For some drivers, there is rarely a cruising cycle as it is difficult for such drivers to retain a constant speed without the use of cruise control.

Normally, modern batteries (e.g. lithium-ion batteries) are rated in charge/discharge cycles until the battery needs replacement. When the battery 120 is new, it is rated for a known capacity, referred to as C (e.g., a C of 100 indicates that the battery 120 will provide 100 A of current for an hour or 50 A of current for two hours, etc.). Therefore, if the battery 120 is new and the capacity of the battery 120 is 100, it will provide 100 A for one hour. Charge/discharge cycles are the greatest enemy of the battery 120. For example, after a few charge/discharge cycles, the battery 120 having C of 100 may only provide 99 A for one hour, a 1% degradation. If that much charge originally was able to move the vehicle 300 miles, it would only be capable of moving the vehicle for 297 miles now. After 300-500 charge cycles, the same battery 120 having C of 100 may only provide 80 A for one hour, a 20% degradation, now the range of this vehicle is only 240 miles, a good time to replace the battery 120.

A discharge/charge cycle is typically full discharge followed by a subsequent recharge. In an electric vehicle, the battery 120 is rarely fully discharged, and vehicle manufacturers often use the 80 percent depth-of-discharge (DoD) formula to rate the battery 120. This means that only 80 percent of the available energy is used, and 20 percent remains in reserve. Cycling the battery 120 at less than full discharge increases service life as many vehicle manufacturers argue is closer to a valid representation than a full cycle because batteries are commonly recharged while some spare capacity remains. Therefore, judging battery life on counting cycles for the battery 120 of an electric vehicle is not conclusive because each discharge may vary in depth and there are no clearly defined standards of what constitutes a cycle.

As the life of typical lithium-ion batteries are rated in full charge cycles, these micro charge cycles also count towards the life of such. Therefore, even though the battery 120 is not normally being fully depleted, then fully recharged, there is a cumulative cycle that adds up to a full charge cycle caused by the micro charge cycles. For example, if the 100 C battery has an expected life of 500 full charge cycles and there are 100 micro cycles, each being approximately 1 Ahr, then the 100 micro-charge cycles roughly add up to a full charge cycle. A recent article from Science Direct® in the Journal of Energy Storage, Volume 55, Part A, dated Nov. 1, 2022, titled “Impact of micro-cycles on the lifetime of lithium-ion batteries: An experimental study” implies that tested lithium-ion batteries exhibited a greater total number of equivalent full charge cycles that the number of actual full charge cycles plus the summation of the micro-charge cycles. Even though the micro-charge cycles have less effect on the battery life than the full charge cycles, the constant charging and discharging of the battery 120 in an electric vehicle application adds up to used charge cycles and reduces that life of the battery 120, as there is no way to cluster these micro-charge cycles as battery power is needed when it is needed (e.g., for movement, lights, air conditioning) and charge power is available only when it is available (e.g., when connected to a charging station or when decelerating or braking).

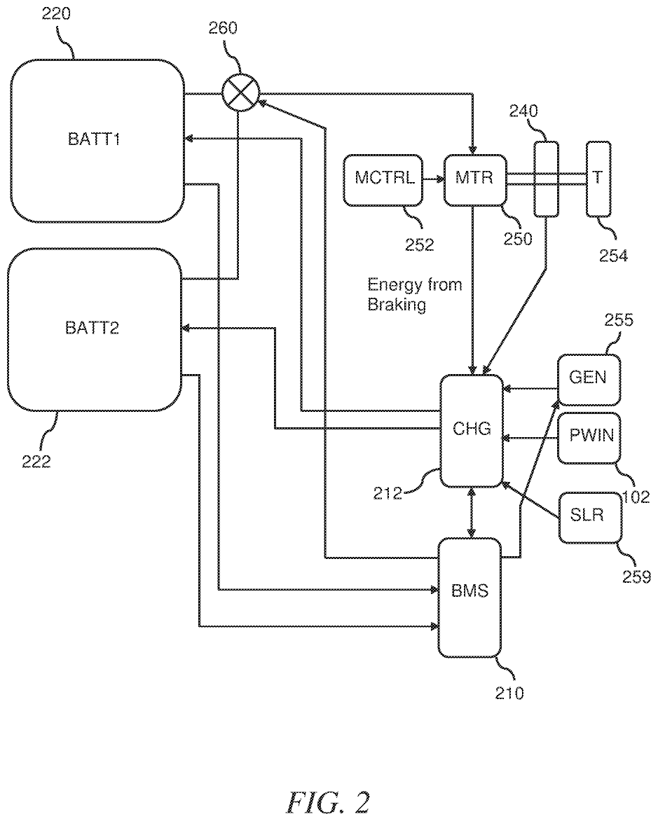

Referring to FIG. 2, a schematic view of an improved electric vehicle power and drive system is shown. To provide improved battery management and allow better control of the number of micro-charge cycles, the improved electric vehicle power and drive system divides the battery cells into two distinct batteries 220/222, a first battery 220 and a second battery 222. Note that in some embodiments, both batteries 220/222 are of the same composition and are interchangeable while in some embodiments, one of the batteries 220/222 has less capacity than the other of the batteries 220/222.

By providing two distinct batteries 220/222, one of the batteries 220/222 will be used to provide power (e.g., to provide power to the motor 150 for vehicle movement by way of tires, propellers, impellers, etc.) and the other one of the batteries 220/222 will be charged as power is available, for example, from deceleration, braking, from an alternate generator(s) 240 that is/are interface to the drive train, from any form of power available such as power from a solar panel 259, or from an on-board power generator 255 (e.g., a fossil fuel or hydrogen powered generator). It is also fully anticipated that for high demands (e.g., when accelerating quickly), both of the batteries 220/222 are available to provide the requisite power for such activities.

Each of the batteries 220/222 are typically made of many battery cells arranged in any format such as in series, parallel, or both. The batteries 220/222 are typically housed beneath the floorboards to provide a good center-of-gravity, as the batteries 220/222 are often very heavy. The batteries 220/222 are connected to drive circuits such as the drive motor(s) 150 through a battery selector 260 by way of very low gauge wires as the maximum amperage drawn is often very high. The battery selector 260 is controlled by the battery management system 210 to route power from one of the batteries 220/222 or both of the batteries 220/222 as needed to power the electric vehicle at the speed and acceleration requested.

The drive system has a motor controller 252 that selectively routes power from the batteries 220/222 to the motor 250 to rotate the tires 254 to move the vehicle in the desired direction. To improve drive distance per charge, the motor controller 252 also captures power from an on-board generator 255 and the motor 250 during deceleration and braking, using this power to provide some charge to one or both of the batteries 220/222 through the battery charge circuit 212.

When the electric vehicle is provided with an external power input 102 (e.g., connected to a charge station), the charge circuit 212 charges one or both of the batteries 220/222, as controlled by a battery management system 210 that monitors the available charge from each of the batteries 220/222 and calculates future available drive distance based upon usage data (e.g., average discharge from the batteries 220/222) and total charge available. Details of the charge circuit 212 are omitted for clarity and brevity reasons as the exact charge circuit 212 depends upon the specifications of the individual battery cells, battery makeup, manufacturer, and arrangement within the batteries 220/222. Further, the charge circuit 212 is dependent upon the type of charge station that it designed to for charging, requiring different voltage level conversions and/or AC-to-DC conversions. Also, the battery management system 210 is described as monitoring the charge level of each of the two batteries 220/222, though it is fully anticipated that the battery management system 210 monitor other parameters such as temperature of the two batteries 220/222, ambient temperature, humidity, service period of the two batteries 220/222, etc.

Note that during a typical usage scenario of a 10-minute drive to work, most electric vehicles will experience many acceleration intervals, cruising intervals, deceleration intervals, and stops, each causing periodic discharges of varying current draws (e.g., acceleration vs. cruising) and charge cycles (e.g., deceleration and braking). For some drivers, there is rarely a cruising cycle as it is difficult for such drivers to retain a constant speed without the use of cruise control.

To reduce and/or control micro-charge cycles, one of the batteries 220/222 provides power to the motor 250 through the battery selector 260 while, any available charge power is provided to the other one of the batteries 220/222. For example, while cruising, power from the first battery 220 is routed from the first battery 220 to the motor 250 through the battery selector 260 while any available charge power is provided to the second battery 222, or visa-versa. Therefore, any available charge power from deceleration, from the on-board power generator 255, from any available alternate form of power such as power from a solar panel 259, etc., is used to charge the second battery 222 as provided through the charge circuit 212 under control of the battery management system 210. In this example, as the second battery 222 approaches full charge or as the first battery approaches minimum charge, the battery management system 210 controls the battery selector 260 to connect the second battery 222 to the motor 250 and the battery management system 210 controls the charge circuit 212 to charge the first battery 220 with any available charge power.

In some embodiments, a generator 240 is interfaced to the drive train, for example, to one or more axles or to one or more wheels. Preferably the generator(s) 240 are high efficiency permanent magnet generators. With such, any motion of the vehicle results in rotation of the wheels and/or axles, resulting in power generated by the generator(s) 240, which is used to charge one of the batteries 220/222. In some embodiments, there will be one generator 240 interfaced to a single axle or, in electric vehicles having two axles, one generator 240 interface to each axle, or in some vehicles, one generator 240 is interfaced to each wheel/tire 254.

In some embodiments, an on-board power generator 255 is provided to extend driving distances by providing charging power to one of the batteries 220/222 (e.g., the one of the batteries 220/222 that is in charge mode). The on-board power generator 255 is controlled by the battery management system 210 to provide charging power to one of the batteries 220/222 (e.g., the one of the batteries 220/222 that is in charge mode) when it is determined that the vehicle will have difficulty reaching a desired destination or to prevent full discharge of one of the batteries 220/222. For example, if the electric vehicle global positioning system is set to go from Atlanta, GA, to Ocala, FL, and, after calculating average usage and present battery capacity of the batteries 220/222, it is determined that either a stop at a charging station is needed or additional battery capacity is needed to reach that destination, the battery management system 210 signals the power generator 255 to operate and produce power and battery management system 210 signals the charge circuit 212 to charge the one of the batteries 220/222 using this power. In this way, fuel used by the power generator 255 (e.g., fossil fuel, hydrogen, etc.) is preserved until needed. In such a scenario, it is fully anticipated that the user (e.g., driver) have the ability to program a stop at a charging station via the global positioning system or to suppress operation of the power generator 255 and operate the electric vehicle as if there was no power generator 255, requiring a stop as the total capacity of the batteries 220/222, as calculated, are not predicted to permit the electric vehicle reach the desired destination (e.g., the driver will receive a warning to recharge when the batteries 220/222 reach a certain capacity).

As can be understood from the above, the presently described system is anticipated to provide better life from the batteries 220/222 by controlling the number of micro-charge cycles, by managing the batteries 220/222 to reduce overcharging and undercharging, and to provide power from an on-board power generator 255 only when needed so as to conserve fuel that is provided to the generator.

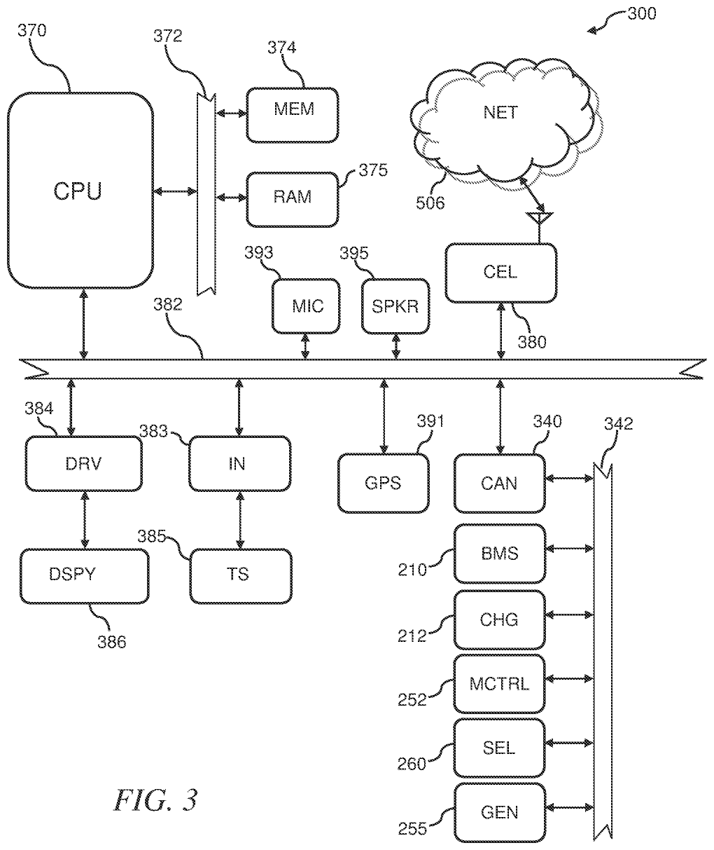

Referring to FIG. 3, a block diagram of an exemplary on-board computer 300 is shown. The on-board computer 300 is a processor-based device for providing control and communications of the electric vehicle. The present invention is in no way limited to any particular on-board computer 300 and many other configurations are anticipated having one or more processors or having discrete logic implementing similar or equivalent functionality.

The on-board computer 300 represents a typical device used for operating the electric vehicle. This on-board computer 300 is shown in its simplest form. Different architectures are known that accomplish similar results in a similar fashion, and the present invention is not limited in any way to any particular system architecture or implementation. In this exemplary on-board computer 300, a processor 370 executes or runs programs in a random-access memory 375. The programs are generally stored within a persistent memory 374 and loaded into the random-access memory 375 when needed. The processor 370 is any processor, typically a processor suited for electric vehicle operations. The persistent memory 374 and random-access memory 375 are typically connected to the processor 370 by, for example, a memory bus 372. The random-access memory 375 is any memory suitable for connection and operation with the processor 370, such as SRAM, DRAM, SDRAM, RDRAM, DDR, DDR-2, etc. The persistent memory 374 is any type, configuration, capacity of memory suitable for persistently storing data in a vehicular application, for example, flash memory, read only memory, battery-backed memory, etc.

Also connected to the processor 370 is a system bus 382 for connecting to peripheral subsystems such as a wireless network interface 380 (e.g., Cellular or Wi-Fi), a display driver 384 for driving a display device 386 (e.g., dashboard display), an input port 383 for reading touch inputs from a touch screen interface 385 or other switches and controls of the electric vehicle, optionally an audio input device 393, and audio transducer 395, though there is no restriction on types and configurations of inputs and outputs.

In general, some portion of the persistent memory 374 is used to store executable code, and data, etc.

The peripherals are examples, and other devices are known in the industry such as a global positioning subsystem 391, the details of which are not shown for brevity and clarity reasons.

The wireless network interface 380 connects the on-board computer 300 to the data network 506 through any known or future protocol such as Ethernet, WI-FI, GSM, TDMA, LTE, etc. There is no limitation on the type of connection used. The wireless network interface 380 provides data and messaging connections between the on-board computer 300 and, for example, other vehicles or a central control system.

The on-board computer 300 includes a local interface 340 to various subsystems of the electric vehicle, often called car-area network (CAN) or vehicle-area network (VAN). The local interface provides communications between the on-board computer and various other devices within the electric vehicle such as light controls, cameras, sensors, the battery management system 210, the charge circuit 212, the motor control(s) 252, the battery selector 260 and the power generator 255. For example, the initiate operation of the generator, the on-board computer 300 signals the local interface 340 to send a command to the power generator 255 over the local network 342, the command indicating that the power generator 255 should start producing electricity.

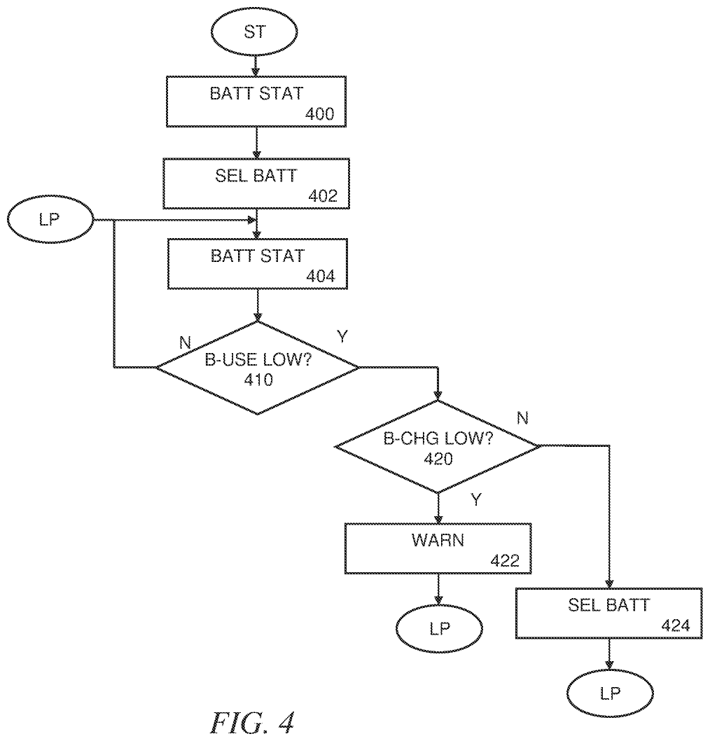

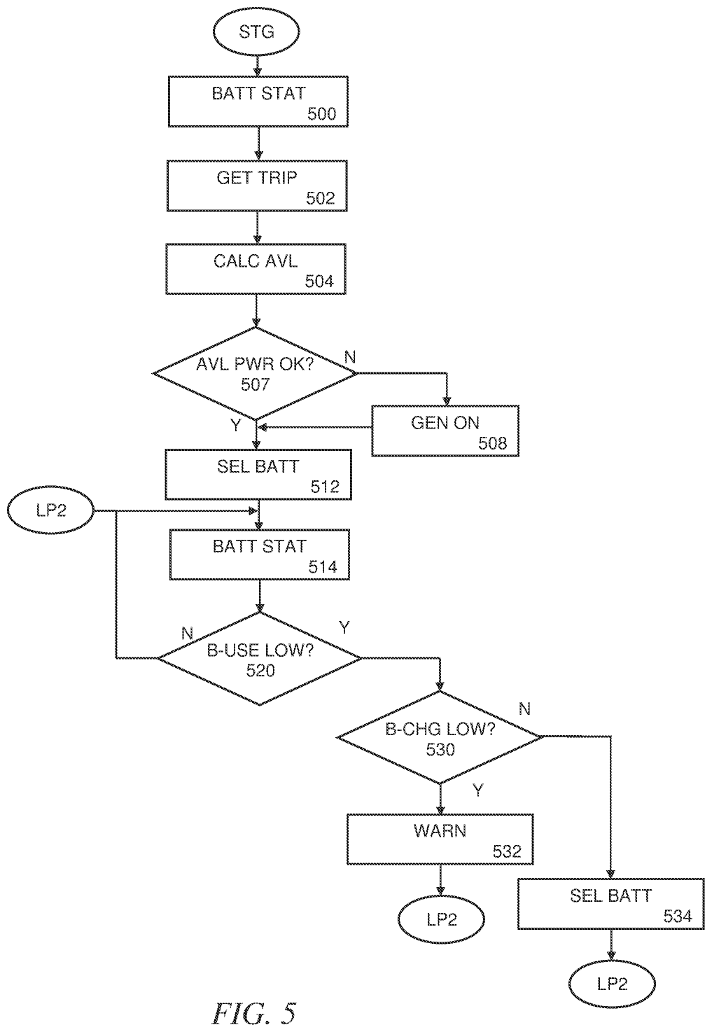

Referring to FIGS. 4 and 5, exemplary program flow charts for selecting which battery is used for which purpose are shown. Throughout this description, one of the two batteries 220/222 will be designated the use-battery (the battery that is being drained to operate the electric vehicle) and the other one of the two batteries 220/222 will be designated the charge-battery (the battery that is being charged whenever any form of charging power is available, for example, during motion, during deceleration/braking, when solar power is available, etc.)

In FIG. 4, the battery management system 210 is used to get a charge status 400 of each of the two batteries 220/222. Next, one of the two batteries 220/222 is selected 402, for example, the battery of the two batteries 220/222 having the highest charge level is selected to operate the vehicle (use-battery) and the battery of the two batteries 220/222 having the lowest charge level is selected to be charged (charge-battery). Now, in a loop, the battery management system 210 is again used to get a charge status 404 of each of the two batteries 220/222 and a test 410 is performed to determine if the charge level of the use-battery is below a certain threshold (e.g., low charge level). If not, the loop repeats. If the charge level of the use-battery is below a certain threshold, then if the charge level of the charge-battery is low 420 (e.g., both of the two batteries 220/222 are low), a warning 422 is emitted (e.g., an indicator is illuminated and/or a sound is made) as the electric vehicle is almost out of energy and will soon stop. The loop continues. If the charge level of the charge-battery is not low 420, then that battery is selected 424 to be the use-battery and the loop continues.

In FIG. 5, a generator is available, powered by fuel such as fossil fuel (e.g., propane), hydrogen, of any available fuel source. The battery management system 210 is used to get a charge status 500 of each of the two batteries 220/222. Next, the route of the trip to be taken is obtained 502, for example, by user input (e.g., indicating that they will be driving 85 miles) or by communicating with the global positioning subsystem 391 to read the trip distance and, optionally, information about the terrain and traffic patterns of the trip, as stop and go traffic often negatively effects the efficiency of a vehicle. The available power is calculated 504 from the battery status, for example, given the terrain, the batteries 220/222 have sufficient power to travel a certain distance. Next, a test 507 is performed to determine if the available power is sufficient to complete the trip. If the available power is not sufficient to complete the trip, the power generator 255 is initiated 508.

Now, one of the two batteries 220/222 is selected 512, for example, the battery of the two batteries 220/222 having the highest charge level is selected to operate the vehicle (use-battery) and the battery of the two batteries 220/222 having the lowest charge level is selected to be charged (charge-battery). Now, in a loop, the battery management system 210 is again used to get a charge status 514 of each of the two batteries 220/222 and a test 520 is performed to determine if the charge level of the use-battery is below a certain threshold (e.g., low charge level). If not, the loop repeats. If the charge level of the use-battery is below a certain threshold, then if the charge level of the charge-battery is low 530 (e.g., both of the two batteries 220/222 are low), a warning 532 is emitted (e.g., an indicator is illuminated and/or a sound is made) as the electric vehicle is almost out of energy and will soon stop. The loop continues. If the charge level of the charge-battery is not low 530, then that battery is selected 534 to be the use-battery and the loop continues.

The above is an example of part of the software flow. It is fully anticipated that after the trip, the power generator 255 will be stopped, various lighting decisions are made, etc. Further, it is also anticipated that, during the trip, periodic calculations of available power are made and, if the generator was not originally initiated 508, when it is determined that it may be difficult to complete the trip, for example, unforeseen power is depleted due to excess traffic or other usage, the power generator 255 is initiated 508.

If should be noted that another advantage of two batteries 220/222 is that the two batteries 220/224 be located on each side of the chassis of the electric vehicle allowing for a center Accessory Channel 14 for wiring and other preferred or necessary components to pass.

In some embodiments, the power generator 255 includes a high-efficiency generator mechanism interfaced to a hydrogen-powered motor as hydrogen is a stable fuel that produces minimal emissions. The fuel for the hydrogen-power motor is envisioned to be provided in canisters (much like propane camping canisters) that are easily exchangeable by the electric vehicle owner.

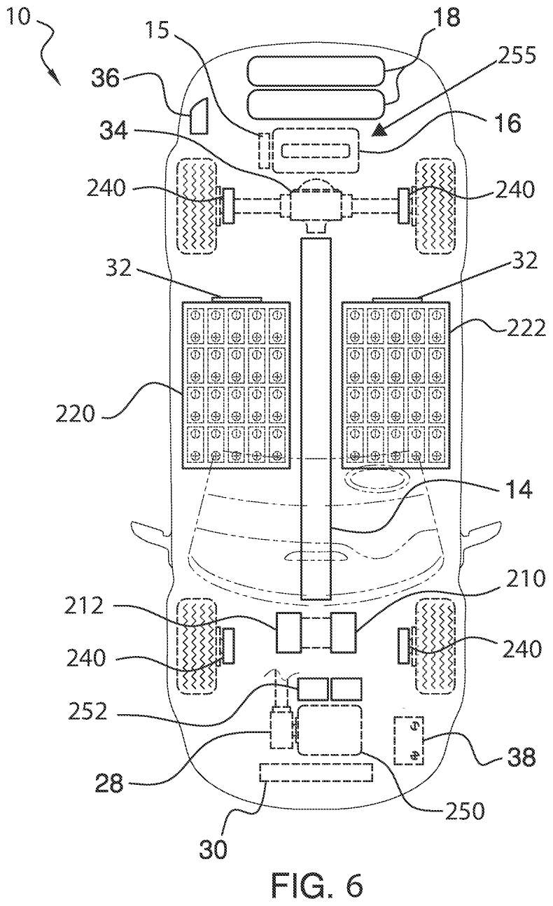

Referring to FIG. 6, a schematic view of an improved electric vehicle 10 with the new power and drive system is shown. In this, the power generator 255 is shown having a motor 16 and a generator 15 (e.g., a hydrogen powered motor and a high efficiency, permanent magnet generator). In this example, two fuel canisters 18 are shown (e.g., canister for storing and delivering hydrogen gas to the hydrogen powered motor, though any number of fuel canisters 18 are anticipated.

An input power connector 36 is included for connecting to input power from a power source such as a charging station. The power from the input power connector is routed to the charge circuit 212.

In this example, there are four generators 240, one on each wheel and a fifth generator 255 providing supplemental power.

The two batteries 220/222 are positioned centrally with space between them allowing for a corridor 14 (e.g., for housing cables and power trains). There is also a differential 34 shown for completeness.

The battery management system 210 and charge circuit 212 are shown as two separate entities, though any arrangement is anticipated. The battery selector 260 is also shown. The motor control 252 controls power going to the motor 250. In this embodiment, the motor is connected to a gear box.

In some embodiments, a standard lead-acid (or other) car battery 38 is included in the electric vehicle 10 as is a thermal cooling exchanger 30. In some embodiments, the motor 250 is coupled to the wheels through various drive mechanisms 28.

The thermal cooling exchanger 30 is selectively interfaced to each of the battery compartments in which the two distinct batteries 220/222 are housed for cooling when needed. In some embodiments, for operation during low temperatures, it is needed to preheat one of both of the two distinct batteries 220/222, for example, when one of the two distinct batteries 220/222 is fully charged and not being used. To provide heat to one or both battery compartments of the two distinct batteries 220/222, heaters 32 (e.g., resistance or induction heating elements with or without blowers). In this way, when one of the two distinct batteries 220/222 reaches a certain temperature (too cold), the heater 32 associated with that one of the two distinct batteries 220/222 is energized to heat that battery.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A system for powering an electric vehicle, the system comprising:
two independent rechargeable batteries, each battery of the two independent rechargeable batteries comprising a plurality of battery cells;
a battery management system interfaced to a charge controller and a battery selector, the charge controller electrically interfaced to each of the two independent rechargeable batteries for selectively charging one or both of the two independent rechargeable batteries when charge power is available, and the battery selector electrically interfaced to each of the two independent rechargeable batteries for routing electric energy from one or both of the two independent rechargeable batteries to power the electric vehicle; and
whereas the battery management system controls the charge controller and the battery selector to charge a first battery of the two independent rechargeable batteries and route the electric energy from a second battery of the two independent rechargeable batteries during normal operation.

2. The system for powering the electric vehicle of claim 1, whereas the battery management system controls the charge controller and the battery selector to route the electric energy from both the first battery and the second battery during high demand operation.

3. The system for powering the electric vehicle of claim 1, further comprising a generator interfaced to a drive train of the electric vehicle such that, during any forward or reverse movement of the electric vehicle, the generator providing the electric energy to the charge controller for charging of one or both of the two independent rechargeable batteries.

4. The system for powering the electric vehicle of claim 1, further comprising a fuel-powered generator electrically interfaced to the charge controller for providing the electric energy to the charge controller for charging one or both of the two independent rechargeable batteries.

5. The system for powering the electric vehicle of claim 4, wherein the fuel-powered generator is powered by hydrogen fuel provided in canisters, the canisters contained within the electric vehicle.

6. The system for powering the electric vehicle of claim 4, wherein the fuel-powered generator is powered by fossil-fuel provided in a refillable tank, the refillable tank contained within the electric vehicle.

7. The system for powering the electric vehicle of claim 1, further comprising at least one alternate source of power electrically interfaced to the charge controller for providing the electric energy to the charge controller for charging one or both of the two independent rechargeable batteries.

8. The system for powering the electric vehicle of claim 7, wherein the at least one alternate source of power is from a solar panel.

9. A method for powering an electric vehicle, the method comprising:
providing two independent rechargeable batteries, each battery of the two independent rechargeable batteries comprising a plurality of battery cells;
controlling charging of each of the two independent rechargeable batteries such that charging is provided to a first battery of the two independent rechargeable batteries while sourcing electrical power from a second battery of the two independent rechargeable batteries for use by the electric vehicle; and
when the second battery of the two independent rechargeable batteries reaches a low-battery threshold, controlling charging of each of the two independent rechargeable batteries such that charging is provided to the second battery of the two independent rechargeable batteries while sourcing an electrical power from the first battery of the two independent rechargeable batteries for use by the electric vehicle.

10. The method of claim 9, further comprising sourcing the electrical power from both the first battery of the two independent rechargeable batteries and the second battery of the two independent rechargeable batteries for use by the electric vehicle when needed.

11. The method of claim 9, further comprising providing of a generator that is interfaced to a drive train of the electric vehicle, the generator creating electrical energy during any forward or reverse movement of the electric vehicle for charging of one or both of the two independent rechargeable batteries.

12. The method of claim 9, further comprising providing of a fuel-power generator for charging one or both of the two independent rechargeable batteries.

13. The method of claim 12, further comprising providing fuel to the fuel-power generator by hydrogen fuel provided in canisters, the canisters contained within the electric vehicle.

14. The method of claim 12, further comprising providing fuel to the fuel-power generator from fossil-fuel provided in a refillable tank, the refillable tank contained within the electric vehicle.

15. The method of claim 9, further comprising providing electric energy for charging from at least one alternate power source, the at least one alternate power source comprising at least one solar panel, when exposed to light, the at least one solar panel providing electric energy for charging one or both of the two independent rechargeable batteries.

16. A system for powering an electric vehicle, the system comprising:
two independent rechargeable batteries, each battery of the two independent rechargeable batteries comprising a plurality of battery cells;
means for charging each of the two independent rechargeable batteries;
means for drawing electrical energy from one or both of the two independent rechargeable batteries; and
whereas during normal operation of the electric vehicle, a first battery of the two independent rechargeable batteries is charged from any available charge potential and a second battery of the two independent rechargeable batteries is utilized to power the electric vehicle.

17. The system for powering the electric vehicle of claim 16, whereas during high-demand operation of the electric vehicle, the first battery of the two independent rechargeable batteries and the second battery of the two independent rechargeable batteries is utilized to power the electric vehicle.

18. The system for powering the electric vehicle of claim 16, whereas the any available charge potential is provided by a generator, the generator interfaced to a drive train of the electric vehicle such that, during any forward or reverse movement of the electric vehicle, the generator provides the any available charge potential for charging of one or both of the two independent rechargeable batteries.

19. The system for powering the electric vehicle of claim 16, whereas the any available charge potential is provided by a fuel-powered generator, the fuel-powered generator provides the any available charge potential for charging of one or both of the two independent rechargeable batteries.

20. The system for powering the electric vehicle of claim 16, whereas the any available charge potential is provided by an alternate power source, the alternate power source comprising at least one solar panel, the at least one solar panel provides the any available charge potential for charging of one or both of the two independent rechargeable batteries.
